(19) United States
(12) Patent Application Publication
(10) Pub. No.: US 2014/0301096 A1
(43) Pub. Date: Oct. 9, 2014

(54) UV-Curable Coating Compositions For A Flow Coating And Flow Coating Methods Using The Same

(71) Applicants: Jae-Beom AHN, Anyang-si (KR); Young-Hoon Choi, Cheonan-si (KR); Young-Seok Kim, Cheonan-si (KR); Soon-Gi Kim, Cheonan-si (KR); Young-Hee Jung, Cheonansi (KR)

(72) Inventors: Jae-Beom AHN, Anyang-si (KR); Young-Hoon Choi, Cheonan-si (KR); Young-Seok Kim, Cheonan-si (KR); Soon-Gi Kim, Cheonan-si (KR); Young-Hee Jung, Cheonansi (KR)

(21) Appl. No.: 14/215,553

(22) Filed: Mar. 17, 2014

(30) Foreign Application Priority Data
Apr. 9, 2013 (KR) 10-2013-0038386

(51) Int. Cl. C09D 7/12; F21S 8/10; C09D 7/00

(52) U.S. Cl. CPC C09D 7/1233; C09D 7/001; F21S 48/10
USPC 362/487; 522/75; 427/508; 427/420

(57) ABSTRACT

An UV-curable coating composition for a flow coating comprises about 20 to about 35 parts by weight of an aliphatic urethane acrylate oligomer having an unsaturated group; about 15 to about 25 parts by weight of an acrylate monomer having a trifunctional or tetrafuntional unsaturated group; about 1 to about 4 parts by weight of an additive agent including an UV absorbent and a light stabilizer; about 1 to about 3 parts by weight of a photoinitiator; and about 38 to about 55 parts by weight of an alcohol-based or ether-based solvent.

### CROSS-REFERENCE TO RELATED APPLICATION

This application claims priority under 35 USC §119 to Korean Patent Application No. 10-2013-0038386 filed on Apr. 9, 2013 in the Korean Intellectual Property Office (KIPO), the entire disclosure of which is herein incorporated by reference.

### BACKGROUND

1. Field

Example embodiments relate to UV-curable coating compositions for a flow coating and flow coating methods using the same.

2. Description of the Related Art

Polycarbonate-based materials having good transparency, impact resistance and thermal resistance are widely used for an automobile head lamp. However, the polycarbonate-based materials may have poor hardness and durability, and thus a coating composition may be applied on the automobile head lamp to improve hardness and durability thereof and to prevent a scratch generated therefrom. Referring to Korean Patent Application Publications No. 10-1999-0073009 and No. 10-2011-0050952, UV-curable coating compositions for forming a coating layer are disclosed.

However, the conventional UV-curable coating composition may be suitable for a spray coating method, and may include a volatile organic solvent in an amount of greater than about 60% based on a total amount of the composition. In this case, about 70% of the solvent may not be adsorbed or attached on an object to be vaporized. Thus, a large amount of the composition may be required to form the predetermined coating layer to result in air pollution.

In consideration of the above mentioned problems, a flow coating method has been developed. In the flow coating method, a coating composition may be spilled on an object, and a portion of the coating composition which is not adsorbed or attached on the object may be collected and reused. An amount of a vaporized solvent in the flow coating method may be significantly less than that in the spray coating method. Further, an over-spilled portion of the coating composition may be resued or recycled to reduce the air pollution. Even though the coating composition has a great viscosity, the coating composition may be coated by the flow coating method. Thus, an amount of the solvent may be reduced for preparing the coating composition, and a non-solvent type coating composition may be implemented in the flow coating method.

However, if the flow coating method is carried out using the conventional coating composition, polycarbonate in the object may be corroded by a monomer and/or an organic solvent included in the coating composition to result in a blushing phenomenon due to a poor chemical resistance of polycarbonate and/or a longer residence time of the coating composition. Additionally, as the recycled number of the coating composition becomed increased, the viscosity of the coating composition may not be increased to cause a poor workability

### SUMMARY

Example embodiments provide an UV-curable coating composition for a flow coating having improved mechanical and chemical characteristics.

Example embodiments provide a flow coating method using an UV-curable coating composition having improved mechanical and chemical characteristics.

According to example embodiments, there is provided an UV-curable coating composition for a flow coating. The UV-curable coating composition includes about 20 parts by weight to about 35 parts by weight of an aliphatic urethane acrylate oligonmer having an unsaturated group; about 15 parts by weight to about 25 parts by weight of an acrylate monomer having a trifunctional or a tetrafuntional unsaturated group; about 1 part by weight to about 4 parts by weight of an additive including an UV absorbent and a light stabilizer; about 1 part by weight to about 3 parts by weight of a photoinitiator; and about 38 parts by weight to about 55 parts by weight of an alcohol-based or ether-based solvent.

In example embodiments, the aliphatic urethane acrylate oligomer may have a hexafunctional to a decafuntional unsaturated group, and have a number average molecular weight of about 1,000 to about 2,000.

In example embodiments, the acrylate monomer may include trimethylolpropane triacrylate (TMPTA), pentaerythritol triacrylate (PETA) and/or pentaerythritol tetraacrylate (PET4A).

In example embodiments, the alcohol-based solvent may include methyl alcohol, ethyl alcohol, normal propyl alcohol, isopropyl alcohol, normal butyl alcohol, isobutyl alcohol, 2-butyl alcohol and/or diacetone alcohol, and the ether-based solvent may include ethylene glycol ethyl ether, ethylene glycol hexyl ether, propylene glycol methyl ether, propylene glycol propyl ether, propylene glycol butyl ether, propylene glycol tertiary butyl ether, propylene glycol phenyl ether and/or dipropylene glycol methyl ether.

According to example embodiments, there is provided a flow coating method. In the method, an UV-curable coating composition described in claim 1 is coated on a first object including polycarbonate to form a first preliminary coating layer. An over-spilled UV-curable coating composition is collected. The over-spilled UV-curable coating composition is coated on a second object including polycarbonate to form a second preliminary coating layer.

In example embodiments, the first and second objects may be an automobile head lamp.

In example embodiments, the UV-curable coating composition may include isopropyl alcohol or propylene glycol which may be provided as a solvent.

In example embodiments, after forming a first preliminary coating layer, a first UV curing process may be performed to form a first coating layer on the first object. After forming a second preliminary coating layer, a second UV curing process may be performed to form a second coating layer on the second object.

According to example embodiments, there is provided an automobile head lamp. The automobile head lamp includes a coating layer formed by coating and curing an UV-curable coating composition described in claim 1.

### BRIEF DESCRIPTION OF THE DRAWINGS

FIG. 1 illustrates a measuring apparatus for evaluating a recycling ratio of an UV-curable coating composition for a flow coating in accordance with example embodiments.

### DESCRIPTION OF EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

UV-Curable Coating Compositions for a Flow Coating

According to example embodiments, an UV-curable coating composition for a flow coating may be used for forming a coating layer on an object including polycarbonate. The UV-curable coating composition may include an aliphatic urethane acrylate oligomer having an unsaturated group and an acrylate monomer having an unsaturated group which may be provided as resin components. The UV-curable coating composition may further include an additive including an UV absorbent and a light stabilizer, a photoinitiator, and a non-volatility solvent.

In example embodiments, the UV-curable coating composition may include about 20 parts by weight to about 35 parts by weight of the aliphatic urethane acrylate oligomer having an unsaturated group; about 15 parts by weight to about 25 parts by weight of the acrylate monomer having a trifunctional or a tetrafunctional unsaturated group; about 1 part by weight to about 4 parts by weight of the additive including the UV absorbent and the light stabilizer; about 1 part by weight to about 2.5 parts by weight of a photoinitiator; and a remainder of an alcohol-based or ether-based solvent, with respect to 100 parts by weight of a total amount of the UV-curable coating composition

In one example embodiment, the aliphatic urethane acrylate oligomer may have a hexafunctional to a decafunctional unsaturated group, and have a number average molecular weight of about 1,000 to about 2,000.

If the unsaturated group of the aliphatic urethane acrylate oligomer is smaller than hexafunctional, a coating layer obtained from the UV-curable coating composition by a flow cating method may have a low curing density, and thus mechanical characteristics of the coating layer may be deteriorated. If the unsaturated group of the aliphatic urethane acrylate oligomer is greater than decafunctional, the coating layer may be vulnerable to a shrinkage during a curing process and/or a drying process, and thus cracks may be generated at a surface of the coating layer.

In one example embodiment, the aliphatic urethane acrylate oligomer may have a hexafunctional to a octafunctional unsaturated group.

If the number average molecular weight of the aliphatic urethane acrylate oligomer is less than about 1,000, the coating layer may have a high curing density, and thus an adhesion of the coating layer may be decreased. If the number average molecular weight of the aliphatic urethane acrylate oligomer is greater than about 2,000, the UV-curable coating composition may not be cured partially, and thus mechanical characteristics of the coating layer may be deteriorated.

If an amount of the aliphatic urethane acrylate oligomer is less than about 20 parts by weight, the coating layer may have a poor hardness. If the amount of the aliphatic urethane acrylate oligomer is greater than about 35 parts by weight, a viscosity of the UV-curable coating composition may be increased to cause a poor workability and cracks at the surface of the coating layer due to a curing shrinkage. In one example embodiment, the UV-curable coating composition for a flow coating may include about 25 parts by weight to about 30 parts by weight of the aliphatic urethane acrylate oligomer.

The acrylate monomer having an unsaturated group may include, e.g., hexanedioldiacrylate (HDDA), tripropyleneglycol diacrylate (TPGDA), trimethylolpropane triacrylate (TMPTA), pentaerythritol triacrylate (PETA), pentaerythritol tetraacrylate (PET4A), dipentaerythritol hexaacrylate (DPHA), etc.

The object including a polycarbonate-based material may be corroded by a monomer. In example embodiments, bifunctional monomers including HDDA and TPGDA which may cause a corrosion of the polycarbonate-based material may be excluded from the acrylate monomer having an unsaturated group.

In example embodiments, the UV-curable coating composition may consist essentially of a trifunctional acrylate monomer or a tetrafunctional acrylate monomer. In example embodiments, the acrylate monomer may be selected from TMPTA, PETA and PET4A. These may be used alone or in a combination thereof.

If the unsatrated group of the acrylate monomer is smaller than trifunctional, the object including the polycarbonate-based material may be corroded during a flow coating of the UV-curable coating composition. If the unsatrated group of the acrylate monomer is greater than tetrafunctional, cracks may be generated at the surface of the coating layer due to the curing shrinkage.

If an amount of the acrylate monomer having an unsaturated group is less than about 15 parts by weight, the amount of the oligomer may become realtively larger, and the viscosity of the UV-curable coating composition to cause the poor workability. If the amount of the acrylate monomer having an unsaturated group is greater than about 25 parts by weight, the amount of the oligomer may become relatively smaller, the coating layer may have poor mechanical properties, e.g., the poor hardness. In one example embodiment, the UV-curable coating composition for a flow coating may include about 17 parts by weight to about 22 parts by weight of the acrylate monomer having an unsaturated group.

In example embodiments, the additive may include the UV absorbent and the light stabilizer to improve a durability of the coating layer. The UV-curable coating composition may include about 1 part by weight to about 4 parts by weight of the additive.

For example, the UV absorbent may include a benzotriazol-based UV absorbent and a triazine-based UV absorbent. The benzotriazol-based UV absorbent may include, e.g., 2-(2H-benzotriazol-2-yl)-4,6-ditertpentylphenol (HL) or 2-(2H-benzotriazol-2-yl)-6-(1-methyl-1-phenylethyl)-4-(1,1,3,3-tetramethylbutyl)phenol. The triazine-based UV absorbent may include, e.g. 2-[4-[(2-hydroxy-3-dodesiloxypropyl)oxy]-2-hydroxyphenyl]-4,6-bis(2,4-dimethyl)-1,3,5-tria zine or 2-[4-[(2-hydroxy-3-tridesiloxypropyl)oxy]-2-hydroxyphenyl]-4,6-bis(2,4-dimethyl)-1,3,5-tria zine. In one example embodiment, the triazine-based UV absorbent may be used in consideration of the durability of the coating layer.

In example embodiments, the light stabilizer may include a hindered amine-based light stabilizer, e.g., 2,4-bis[N-butyl-N-(1-cyclohexyloxy-2,2,6,6-tetramethylpiperidine-4-yl)amino]-6-(2-hydroxy ethylamine)-1,3,5-triazine or bis(1,2,2,6,6-pentamethyl-4-piperidine)sebacate.

In one example embodiment, the additive may include the UV absorbent and the light stabilizer in a mixing ratio of about 2:1. If an amount of the additive is less than about 1 part by weight, the coating layer may have the poor durability to cause cracks, detachment and/or yellowing phenomenon at the surface of the coating layer. If the amount of the additive is greater than about 4 parts by weight, the additive may prevent the photoinitiator from absorbing UV light during a curing process to cause a curing of the UV-curable coating composition.

The photoinitiator may form a radical to initiate a polymerization between the oligomer and the monomer in the UV-curable coating composition. In example embodiments, the photoinitiator may include, e.g., 2-hydroxy-2-methyl-1-phenyl-propan-1-one, 1-hydroxy-cyclohexyl-phenyl-ketone, 2,4,6-trimethylbenzoyldiphenylphosphine oxide, 2-hydroxy-1-{4-[4-(2-hydroxy-2-methyl-propionyl)-benzyl]-phenyl}-2-methyl-propan-1-one, benxophenone, etc. These may be used alone or in a combination thereof.

In example embodiments, the UV-curable coating composition may include about 1 part by weight to about 3 parts by weight of the photoinitiator, in one example embodiment, the UV-curable coating composition may include, about 1.5 parts by weight to about 2.5 parts by weight of the photoinitiator. If an amount of the photoinitiator is less than about 1 part by weight, the UV-curable coating composition may not be cured sufficiently to result in the poor mechanical characteristics.

Further, the UV-curable coating composition may not absorb UV light sufficiently due to the light stabilizer, and thus the coating layer may have a poor adhesion. If the amount of the photoinitiator is greater than about 3 parts by weight, a large portion of the photoinitiator may remain unreacted in the composition, and thus the coating layer may have the poor mechanical characteristics.

The solvent may include, e.g., an alcohol-based solvent and/or an ether-based solvent which may not cause the corrosion of the object including the polycarbonate-based material even for a large residence time. Additionally, the alcohol-based solvent and the ether-based solvent may have volatilization rates from about 30 to about 80 when the volatilizaton rate of butyl acetate is set as 100. Accordingly, the composition including the solvent may have substantially constant viscosity and content ratio of components even in repeated reuse or recycling.

If the volatilization rate of the solvent is less than about 30, the solvent may not be removed sufficiently during a curing process, so that the coating layer may have the deteriorated mechanical characteristics. If the volatilization rate of the solvent is greater than about 80 the solvent may be excessively volatilized during a formation of the coating layer, and thus the composition may not be easily reused or recycled.

In example embodiments, the UV-curable coating composition may include about 38 parts by weight to about 55 parts by weight of the solvent in consideration of the workability and the recycling process of the composition. In one example embodiment, the UV-curable coating composition may include about 40 parts by weight to about 50 parts by weight of the solvent.

As describe above, the UV-curable coating composition may be applied on the object containing the polycarbonate-based material to improve the hardness and the durability thereof. The UV-curable coating composition may not deteriorate a transparency of the object and may be reused or recycled in the flow coating method. A volatilized amount of the UV-curable coating composition may be minimized in a recycling process to prevent a viscosity of the composition from being increased. Thus, the workability of a coating process may be steadily maintained,

Flow Coating Methods Using UV-Curable Coating Compositions

According to example embodiments, a coating layer may be formed on an object including a polycarbonate-based material using the UV-curable coating composition in accordance with example embodiments by the following process.

In a first process, the UV-curable coating composition may be flow coated on a first object including polycarbonate to form a first preliminary coating layer. In one example embodiment, the first object may be an automobile head lamp. Detailed descriptions on components or ingredients of the UV-curable coating composition are omitted.

The first object on which the first preliminary coating layer is formed may be transferred into a drying chamber, and an UV curing process may be performed to form a first coating layer.

In a second process, an over-spilled or over-flown portion of the UV-curable coating composition may be collected. The over-spilled or over-flown portion of the composition may be collected in an additional collection tank.

The collected compostion may be reused and applied on a second object to form a second preliminary coating layer.

The second objection which the second preliminary coating layer is formed may be transferred into the drying chamber, and an UV curing process may be performed to form a second coating layer.

The first and second coating layers may be substantially transparent and have an enhanced hardness.

Hereinafter, Properties of the UV-Curable Coating Composition are Described in More Detail with Reference to Examples and Comparative Examples.

Preparation of UV-Curable Coating Compositions for a Flow Coating

An aliphatic urethane acrylate oligomer having an unsaturated group (A), an acrylate monomer having an unsaturated group (B), an UV absorbent (D), a light stabilizer (E), a photoinitiator (F) and a solvent (C) were combined by mixition rations shown in Table 1 below to prepare UV-curable coating compositions of Examples and Comparative Examples, composition Example Comparative Comparative Example Comparative Examples.

TABLE 1

| | | Content (wt %) | | | | | |
|---|---|---|---|---|---|---|---|
| | | Example | Comparative | Comparative | Example | Comparative | Comparative |
| composition | | 1 | Example 1 | Example 2 | 2 | Example 3 | Example 4 |
| A | hexafunctional | 27 | 27 | 27 | 27 | 27 | 27 |
| | aliphatic urethane | | | | | | |
| | acrylate oligomer | | | | | | |
| B | HDDA | — | 20 | — | — | — | — |
| | TMTPA | 20 | — | — | 20 | 20 | 20 |
| | DPHA | — | — | 20 | — | — | — |
| | isopropyl alcohol | — | — | — | 48 | — | — |
| C | PGME | 48 | 48 | 48 | — | — | 48 |
| | butyl acetate | — | — | — | — | 48 | — |
| D | triazine-based UV | 2 | 2 | 2 | 2 | 2 | — |
| | absorbent | | | | | | |
| | benzotriazol-based | — | — | — | — | — | 2 |
| | absorbent | | | | | | |
| E | hindered | 1 | 1 | 1 | 1 | 1 | 1 |
| | amine-based light | | | | | | |
| | stabilizer | | | | | | |
| F | photoinitiator | 2 | 2 | 2 | 2 | 2 | 2 |

| | | | | | | |
|---|---|---|---|---|---|---|
| total | 100 | 100 | 100 | 100 | 100 | 100 |

Evaluation on Recycling Ratios of the Compositions

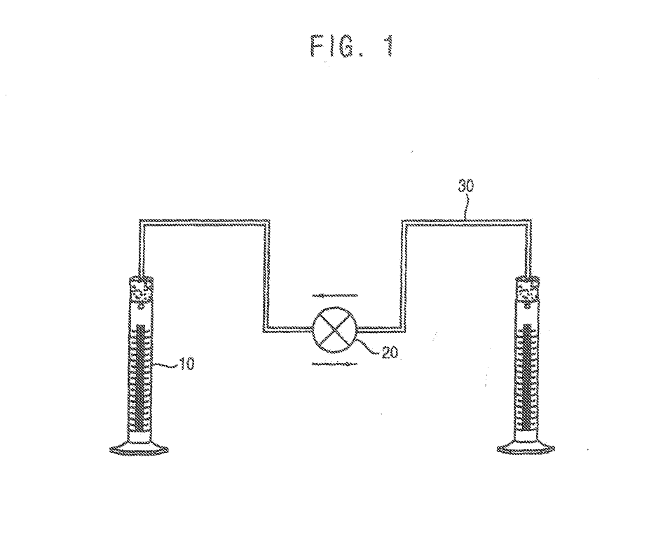

An measuring apparatus as shown in FIG. 1 was set up using two mass cylinder 10 of 1,000 ml, a connector 30, an auto peristaltic pump 30, the coating compositions were supplied to the measuring apparatus and cycled three times with a flow rate of about 100 ml/min using the auto peristaltic pump 30, and collected volumes of the coating compositions were measured to calculate recycling ratios of the coating compositions. The results are shown in Table 3 below. Each of the recycling ratios was an average of the three respective results. The experiment was performed at a temperature of about 22° C. to about 280° C. and a humidity of about 50% to about 70% RH. The recycling ratio was calculated using following Equation 1.

Recycling Ratio(%)=(an amount of the collected coating composition/an amount of the supplied coating composition)×100 [Equation 1]

Evaluation on the Properties of Coating Layers

UV-curable coating compositions in accordance with Examples 1 to 2 and Comparative Examples 1 to 4 were coated on a surface of a plate including a polycarbonate-based material of about 100 mm in width and about 100 nm in length using a coating machine. Thereafter, the UV-curable coating compositions on the surface were dried at a temperature of about 80° C. for 180 sec, and an UV light was irradiated on the surface to form cured coating layers. In this case, the UV light was irradiated with an intensity of about 150 mW/cm² and a quantity of about 2000 mJ/cm². Factors below of the cured coating layers were evaluated, and the results are shown in Table 3 below.

1) Appearance: The haze value of the coating layers was measured using a haze meter (Murakami. Co., HM-150).

2) Adhesion: A taping detachment experiments were performed in accordance with ISO 2409 and JIS K 5600-5-6.

3) Pencil Hardness: The experiments were performed in accordance with ISO 2409 and JIS K 5600-5-6, and it was figured out whether the results are greater than or same as HB.

4) Water Resistance: Samples were dipped in the water at a temperature of about 40±2° C. for 240 hours, the samples were pulled out, and a remained water on the samples was removed by a air blow process. Thereafter, the samples were kept at room temperature for 1 hour, surfaces of the samples were investigated, and attachment experiments were performed.

5) Thermal Resistance: After the coating layers were kept at a temperature of about 80±2° C. for 300 hours, the coating layer were pulled out and kept at room temperature for 1 hour. Thereafter, surfaces of the coating layers were investigated, and attachment experiments were performed.

6) Accelerated durability: After UV light was irradiated on the coating layers in conditions as shown in Table 2 below using a WHETHER-O-METER (Xenon Are defined by ISO 105, JIS L 0843, ASTM D 6695, SAE J 1960. SAE J 2527), surfaces of the coating layers were investigated whether significant discoloration (ΔE* is smaller than or same as 3.0), fading, swelling, cracking and/or poor gloss phenomenon are generated, and attachment experiments were performed.

7) Evaluation Standard: excellent [⊚], good [◯], average [Δ], poor [X]

TABLE 2

| setting | BLACK PNL | | irradiating |
|---|---|---|---|
| condition | temperature | cycles | intensity |
| 2500KJ/m² | 70 ± 2° C. | irradiating 40 minutes(50 ± 5% RH) | 0.55 ± |
| [3400 nm] | (LIGHT) | irradiating 20 minutes(surface spray) | 0.02 W/ |
| | 38 ± 2° C. | irradiating 60 minutes(50 ± 5% RH) | (m² • nm) |
| | (DARK) | non-irradiating 40 minutes | [340 nm] |
| | | (95 ± 5% RH/surface and backside | |
| | | spay) | |

TABLE 3

| | | Example | Comparative | Comparative | Example | Comparative | Comparative |
|---|---|---|---|---|---|---|---|
| | | 1 | Example 1 | Example 2 | 2 | Example 3 | Example 4 |
| evaluation of | recycling rate | 91.2 | 91.0 | 91.3 | 89.4 | 70.2 | 91.3 |
| coating | ( %) | | | | | | |
| compositions | | | | | | | |
| evaluation of | appearance | 0.7 | 70.6 | 1.2 | 1.0 | 0.8 | 0.7 |
| coating | [haze value (%)] | | | | | | |
| layers | adhesion | 100/100 | 100/100 | 95/100 | 100/100 | 100/100 | 100/100 |
| | pencil hardness | HB | H | H | H | H | H |
| | water | | | | | | |
| | resistance | | | | | | |
| | (attachment after | ⊚ | ◯ | X | ⊚ | ⊚ | ⊚ |
| | water-proofing) | | | (0/100) | | | |
| | thermal | | | | | | |
| | resistance | | | | | | |
| | (attachment after | ⊚ | ◯ | Δ | ⊚ | ⊚ | ⊚ |
| | heat-proofing | | | (95/100) | | | |
| | accelerated | ⊚ | — | ◯ | ⊚ | ⊚ | ⊚ |
| | durability | (2.2) | | (2.8) | (2.3) | (2.1) | (3.7) |
| | (ΔE value) | | | | | | (detachment) |

As shown in Table 3, UV-curable coating compositions in accordance with Examples 1 to 2 had a recycling ratio of greater than or same as about 89%, a haze generation ratio of less than about 1%, a good adhesion, a pencil hardness of greater than or same as H and good water resistance, thermal resistance, and accelerated durability. Alternatively, an UV-curable coating composition in accordance with had a high haze generation ratio, so that the accelerated durability of the coating layer formed using Comparative Example 1 could not be measured. In addition, an UV-curable coating composition in accordance with Comparative Example 2 had a poor water resistance, an UV-curable coating composition in accordance with Comparative Example 3 had a poor recycling ratio, and a detachment phenomenon was generated on a coating layer formed using Comparative Example 4 due to a poor accelerated durability thereof. That is, UV-curable coating compositions in accordance with Comparative Examples 1 to 4 were not proper to form a coating layer by a flow coating.

According to example embodiments of the present invention, the UV-curable coating composition may be applied on an object containing polycarbonate, e.g., an automobile head lamp to improve hardness and durability thereof. The UV-curable coating composition may not deteriorate transparency of the object and may be reused or recycled in a flow coating method. A volatilized amount of the UV-curable coating composition may be minimized in a recycling process to prevent a viscosity of the composition from being increased. Thus, a workability of a coating process may be steadily maintained, Further, the UV-curable coating composition may include a small amount of a solvent having less volatility, and thus a pollution degree and a cost of the coating process may be reduced.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An UV-curable coating composition for a flow coating, comprising:
about 20 parts by weight to about 35 parts by weight of an aliphatic urethane acrylate oligomer having an unsaturated group:
about 15 parts by weight to about 25 parts by weight of an acrylate monomer having a trifunctional or a tetrafuntional unsaturated group;
about 1 part by weight to about 4 parts by weight of an additive including an UV absorbent and a light stabilizer;
about 1 part by weight to about 3 parts by weight of a photoinitiator; and
about 38 parts by weight to about 55 parts by weight of an alcohol-based or ether-based solvent.

2. The UV-curable coating composition for a flow coating of claim 1, wherein the aliphatic urethane acrylate oligomer has a hexafunctional to a decafuntional unsaturated group, and a number average molecular weight of the aliphatic urethane acrylate oligomer ranges from about 1,000 to about 2,000.

3. The UV-curable coating composition for a flow coating of claim 1, wherein the acrylate monomer includes at least one selected from the group consisting of trimethylolpropane triacrylate (TMPTA), pentaerythritol triacrylate (PETA) and pentaerythritol tetraacrylate (PET4A).

4. The UV-curable coating composition for a flow coating of claim 1, wherein the alcohol-based solvent includes at least one selected from the group consisting of methyl alcohol, ethyl alcohol, normal propyl alcohol, isopropyl alcohol, normal butyl alcohol, isobutyl alcohol, 2-butyl alcohol and diacetone alcohol, and wherein the ether-based solvent includes at least one selected from the group consisting of ethylene glycol ethyl ether, ethylene glycol hexyl ether, propylene glycol methyl ether, propylene glycol propyl ether, propylene glycol butyl ether, propylene glycol tertiary butyl ether, propylene glycol phenyl ether, and dipropylene glycol methyl ether.

5. A flow coating method, comprising:
coating an UV-curable coating composition described in claim 1 on a first object including polycarbonate to form a first preliminary coating layer;
collecting an over-spilled portion of the UV-curable coating composition; and
coating a collected UV-curable coating composition on a second object including polycarbonate to form a second preliminary coating layer.

6. The method of claim 5, wherein the first and second objects are an automobile head lamp.

7. The method of claim 5, wherein the UV-curable coating composition includes isopropyl alcohol or propylene glycol.

8. The method of claim 5, after forming a first preliminary coating layer, further comprising performing a first UV curing process to form a first coating layer on the first object; and
after forming a second preliminary coating layer, further comprising performing a second UV curing process to form a second coating layer on the second object.

9. An automobile head lamp comprising a coating layer, the coating layer is formed by coating and curing an UV-curable coating composition described in claim 1.
